(19) United States
(12) Patent Application Publication
(10) Pub. No.: US 2022/0082862 A1
(43) Pub. Date: Mar. 17, 2022

(54) MULTI-CURVE MULTI-SECTION ALIGNMENT STRUCTURE FOR ORTHOKERATOLOGY LENS AND METHOD THEREOF

(71) Applicant: BRIGHTEN OPTIX CORP., Taipei City (TW)

(72) Inventors: I-Tsung WU, Taipei City (TW); Wen-Pin LIN, Taipei City (TW); Wen-Kai LI, Taipei City (TW)

(21) Appl. No.: 17/022,981

(22) Filed: Sep. 16, 2020

(51) Int. Cl. G02C 7/04

(52) U.S. Cl. CPC G02C 7/047; G02C 2202/06

(57) ABSTRACT

A multi-curve multi-section alignment structure for an orthokeratology lens and a method thereof are disclosed. The orthokeratology lens includes a base curve formed on a central part of an inner surface thereof, and a reverse curve outwardly formed outside the base curve, an alignment curve outwardly formed outside the reverse curve and configured to align to a cornea of an eyeball, and a peripheral curve outwardly formed outside the alignment curve. The cornea has an alignment region contacting the alignment curve, and the alignment region is divided into sections, and the alignment curve includes alignment sections formed correspondingly in position to the sections and matching curvatures of the sections of the alignment region, so that the orthokeratology lens can be stably aligned with the eyeball, and when a wearer's eyelid is closed, the orthokeratology lens cannot decenter easily.

### BACKGROUND OF THE INVENTION

### 1. Field of the Invention

The present invention relates to a multi-curve multi-section alignment structure for an orthokeratology lens and a method thereof, and more particularly to an orthokeratology lens formed with an alignment curve having alignment sections matching curvatures of a cornea, to make the orthokeratology lens stably align with an eyeball, so that the orthokeratology lens can not decenter easily to, and a base curve of the orthokeratology lens can indeed reshape the cornea of the eyeball.

### 2. Description of the Related Art

In recent years, with the development and innovation of various electronic products and electrical products, these products bring a lot of convenience to people in daily life and work. In particular, more and more electronic products cause widespread use in communications and Internet applications, so many people (such as office workers, students, middle-aged people, and elderly people) spend a lot of time and in the use of electronic products, and such people are usually called as phubbers. However, long-term use of electronic products causes many people's eyes vision loss or damage many people's eyes, and when this conditions are becoming more serious, myopia population is also rapidly increased.

Furthermore, the reason why people have myopia is mismatch between the eye's refraction and axial length, for example, when the eye axis is too long or the corneal curvature is too steep, it causes the image focused at a point to fall in front of the retina, so the visual image blurs. Therefore, in order to correct myopia, it is necessary to reduce the eye's refraction; about 80% of the refraction occurs in the cornea, so reduction of refractive power of the cornea can correct myopia.

The existing methods to correct refractive error mainly include wearing glasses, wearing contact lens, corneal myopia surgery, or wearing orthokeratology lens. There are advantages and disadvantages of above different methods, and the orthokeratology lens will be especially described in following paragraphs. The orthokeratology lens is made of high oxygen rigid gas permeable material. When the orthokeratology lens is worn on an eyeball, a non-uniform layer of tear is sandwiched between the orthokeratology lens and an outer surface of cornea of the eyeball, and the tear can apply a positive pressure on the cornea to remodel epithelial cells; at the same time, when the wearer closes the eye wearing the orthokeratology lens, the cornea is applied a certain pressure by eyelid and the orthokeratology lens. Therefore, after the wearer wears the lens for a sufficient time, central curvature of the wearer's cornea can be gradually flattened and central epithelial layer of the wearer's cornea can be gradually thinned, so that the central portion of the cornea can be flattened and refractive power of the cornea can be reduced, thereby treating the wearer to correct myopia or even return to normal vision.

However, in general, the corneal surface of the eyeball is not a entire and smooth arc, so when being worn on the eyeball, the conventional orthokeratology lens can decenter easily, and the base curve, which is used to apply a slight pressure to the center of the cornea, of the conventional orthokeratology lens may not push on the cornea centrally, and it causes in failure of full myopia correction back to normal vision.

Therefore, how to solve the above-mentioned problems and inconveniences in conventional orthokeratology lens is a key issue in the industry.

### SUMMARY OF THE INVENTION

In order to solve aforementioned conventional problems, the inventors develop a multi-curve multi-section alignment structure for an orthokeratology lens and a method thereof according to collected data, multiple tests and modifications, and years of experience in the industry.

An objective of the present invention is that an orthokeratology lens includes a base curve formed a central part of an inner surface thereof and configured to apply a positive pressure on a surface of a cornea of an eyeball by tears sandwiched between the orthokeratology lens and the cornea, a reverse curve outwardly formed outside the base curve, an alignment curve outwardly formed outside the reverse curve and configured to align on the cornea, and a peripheral curve outwardly formed outside the alignment curve. The cornea has an alignment region formed on a surface thereof and in contact with the alignment curve, and the alignment region is divided into a plurality of sections, and the alignment curve includes a plurality of alignment sections disposed correspondingly in position to the plurality of sections and matching with curvatures of the plurality of sections of the alignment region, respectively. Since the plurality of alignment sections of the alignment curve match the curvature of the cornea, the orthokeratology lens can be stably aligned with the eyeball, and when a wearer's eyelid is closed, the orthokeratology lens can not decenter easily, the tears sandwiched between the base curve of the orthokeratology lens and the cornea of the eyeball can apply a positive pressure on the surface of the cornea, thereby achieving purpose of improving stability of reduction or elimination of myopia.

### BRIEF DESCRIPTION OF THE DRAWINGS

The structure, operating principle and effects of the present invention will be described in detail by way of various embodiments which are illustrated in the accompanying drawings.

FIG. 1 is a top sectional view of a lens of the present invention.

FIG. 2 is a schematic view of an eyeball, according to the present invention.

FIG. 3 is a flowchart of a method of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the Word “comprise” and variations such as “comprises” or “comprising”, will be acknowledged to imply the inclusion of stated elements but not the exclusion of any other elements.

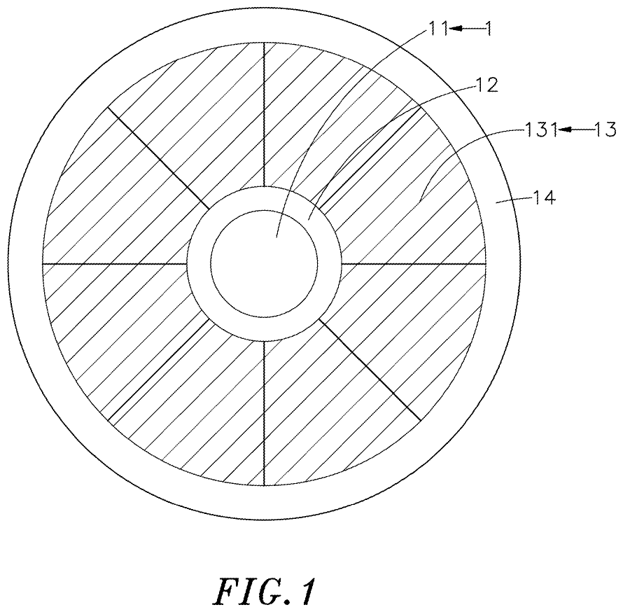

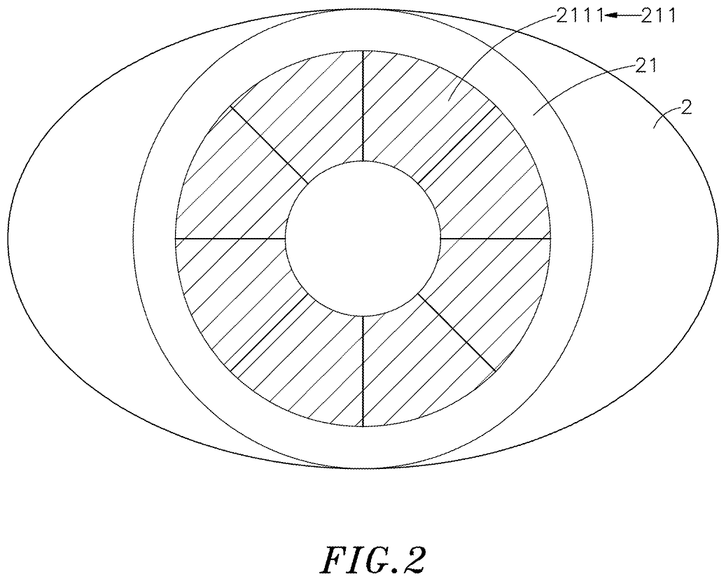

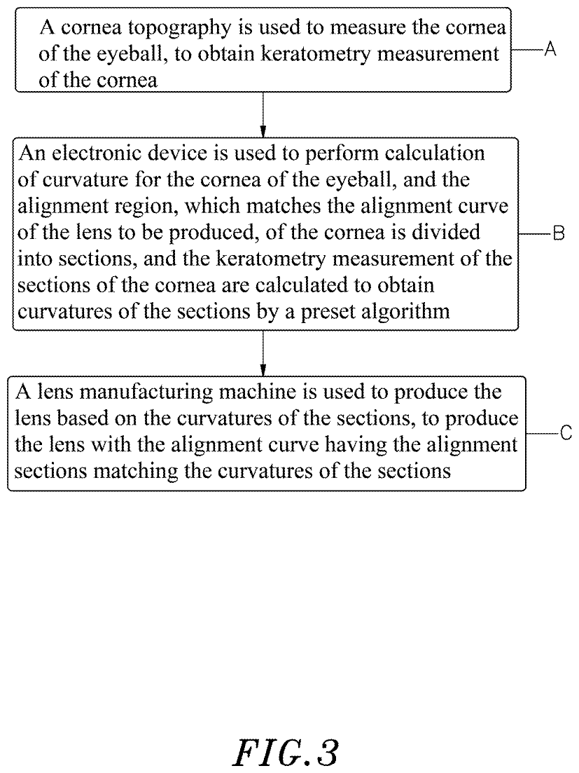

Please refer to FIGS. 1 to 3, which are a top sectional view of a lens of the present invention, a schematic view of an eyeball, and a flowchart of a method of the present invention. As shown in FIGS. 1 to 3, a lens 1 can be an orthokeratology lens which can be worn on an eyeball 2, comprised of circular-arcs and made by material with high oxygen permeability; an inner surface of the lens 1 can be attached on the surface of a cornea 21 of the eyeball 2. The lens 1 further includes a base curve (BC) 11 formed on a central part of the inner surface thereof and configured to apply a positive pressure on the surface of the cornea 21 by tears (not shown in figures) sandwiched between the lens 1 and the cornea 21; and, outsides the base curve 11, the lens 1 further includes, in an order from the inside to the outside, a reverse curve (RC) 12 outwardly formed outside the base curve 11, an alignment curve (AC) 13 outwardly formed outside the reverse curve 12 and configured to align on the cornea 21, and a peripheral curve (PC) 14 outwardly formed outside the alignment curve 13. The cornea 21 has an alignment region 211 formed on a surface thereof and in contact with the alignment curve 13, and the alignment region 211 is divided into a plurality of sections 2111; the alignment curve 13 has a plurality of alignment sections 131 formed correspondingly in position to the plurality of sections 2111 and matching curvatures of the plurality of sections 2111, respectively. The amount of the plurality of sections 2111 can be even number, such as 2, 4, 6, 8, 10 or 12.

Furthermore, a preset curvature of the base curve 11 of the lens 1 is higher than a horizontal curvature of the cornea 21 of the eyeball 2, that is, the curvature of the base curve 11 is flatter than the horizontal curvature of the cornea 21; since the curvature of the base curve 11 is higher than the curvature of the cornea 21, when the lens 1 is worn on the eyeball 2, a positive pressure can be applied on epithelial cells of the cornea 21 by tears sandwiched between the base curve 11 and the cornea 21. Furthermore, the reverse curve 12 of the lens 1 forms a tear reservoir, so that a negative pressure applied by the tears can be used to improve effect of aligning the lens 1 on the eyeball 2.

In a preferable design, the peripheral curve 14 of the lens 1 edge lift can facilitate to squeeze out tears during blinking, to promote the tear exchange inside the lens 1, thereby continuously lubricating the contact area between the lens 1 and the cornea 21 of the eyeball 2 and delivering oxygen. Therefore, with the tear circulation, the orthokeratology lens of the present invention can provide better wearability and comfort when they wear ortho-k lenses.

The nasal curvature of the alignment curve 13 of the lens 1 is lower than the temporal curvature of the alignment curve 13 of the lens 1.

Furthermore, the inner surface of the lens 1 is aspheric.

The practical process of producing the lens 1 of the present invention can include the following steps.

In a step (A), a cornea topography is used to measure the cornea 21 of the eyeball 2, to obtain keratometry measurements of the cornea 21.

In a step (B), an electronic device is used to perform a calculation of curvature for the cornea 21 of the eyeball 2, and the alignment region 211, which matches the alignment curve 13 of the lens 1 to be produced, of the cornea 21 is divided into a plurality of sections 2111, and the keratometry measurements of the plurality of sections 2111 of the cornea 21 are calculated to obtain curvatures of the plurality of sections by a preset algorithm.

In a step (C), a lens production machine is used to produce the lens 1 based on the curvatures of the plurality of sections 2111, to produce the lens 1 with the alignment curve 13 having a plurality of alignment sections 131 matching the curvatures of the plurality of sections 2111, thereby completing production of the lens 1.

It should be noted that the manner of using the cornea topography to measure the cornea 21 of the eyeball 2 to obtain the keratometry measurement of the cornea 21 in the step (A) is a conventional art, so the details of internal electronic component and circuit design of the manner are not repeated herein.

Furthermore, the electronic device used in the step (B) can be, a desktop computer, a notebook computer, an industrial computer, or other electronic device with calculation function.

In the step (B), the electronic device can divide the alignment region 211 of the cornea 21 into the eight sections 2111; for example, during the dividing process, the alignment region 211 of the cornea 21 can be divided into four sections 2111 based on X axis and Y axis first, and each of the four sections is then divided by 45 degrees, so as to divide the alignment region 211 into the eight sections 2111; the eight sections 2111 can be mapped to the alignment curve 13 of the lens 1 to form the eight alignment sections 131 on the alignment curve 13 correspondingly, thereby using the eight alignment sections 131 to improve lens-corneal alignment.

In the step (B), the electronic device can use the central point of the cornea 21 of the eyeball 2 as the original point (0,0) of (X, Y) coordinate system, and the preset algorithm can be expressed as:

$$z = \frac{c {r}^{2}}{1 + \sqrt{1 - ( 1 + k ) {c}^{2} {r}^{2}}}$$

wherein z indicates a distance from the original point in the Y direction, c indicates a curvature of the central point of the cornea 21, r indicates a distance from the original point in the X direction, and k indicates asphericity, k=−e², and e indicates eccentricity.

Furthermore, the lens manufacturing machine used in the step (C) can be an aspheric surface manufacturing machine to produce the lens 1 by an aspheric surface production manner. It should be noted that the lens manufacturing machine includes a lot of internal devices and components which are not key point of the present invention, so their detailed descriptions are not repeated herein.

When a user wants to wear the lens of the present invention, an optometrist can use the corneal topography to measure the cornea 21 of the wearer's eyeball 2 to obtain keratometry measurement of the wearer's cornea 21; the corneal topography can transmit the keratometry measurement to the electronic device, and at this time, an optometrist can use the electronic device to perform calculation of curvature, to divide the alignment region 211, which matches the alignment curve 13 of the lens 1 to be produced, of the cornea 21 into the sections 2111, and then calculate the keratometry measurement of the sections 2111 of the cornea 21 to obtain the curvatures of the sections 2111 by the preset algorithm. Next, the electronic device can transmit the curvatures of the cornea 21 to the lens manufacturing machine, and the lens manufacturing machine can produce the lens 1 based on the curvatures of the sections 2111, so that the alignment curve 13 of the lens 1 can have the alignment sections 131 matching with the curvatures of the sections 2111. When the wearer wears the produced lens 1 on the eyeball 2 thereof; the inner surface of the lens 1 can contact the surface of the cornea 21 of the eyeball 2; since the alignment curve 13 is formed with the alignment sections 131 matching the curvatures of the cornea 21, the lens 1 can be stably aligned with the eyeball 2. When the wearer goes to bed at night and closes eyelids (not shown in figures), the lens 1 can not decenter easily, and tears sandwiched between the base curve 11 of the lens 1 and the cornea 21 can indeed apply a positive pressure on epithelial cells on the central part of the surface of the cornea 21 of the eyeball 2, the epithelial cells on the surface of the cornea 21 can be pressed by the tears to make the curvature of the central cornea 21 gradually become flatter, to further make the central corneal epithelium become thinner, so as to reduce refractive power of the cornea 21 and move the image focus point toward the retina (not shown in figures) of the eyeball 2, thereby achieving the effect of improving stability of reduction or elimination of myopia.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A multi-curve multi-section alignment structure for an orthokeratology lens, wherein the orthokeratology lens comprises a base curve formed on a central part of an inner surface thereof and configured to apply a positive pressure on a surface of a cornea of an eyeball by tears sandwiched between the lens and the cornea, a reverse curve outwardly formed outside the base curve, an alignment curve outwardly formed outside the reverse curve and configured to align on the cornea, and a peripheral curve outwardly formed outside the alignment curve, wherein the cornea comprises an alignment region in contact with the alignment curve, and the alignment region is divided into a plurality of sections, and the alignment curve comprises a plurality of alignment sections formed correspondingly in position to the plurality of sections and matching curvatures of the plurality of sections of the alignment region.

2. The multi-curve multi-section alignment structure according to claim 1, wherein the amount of the plurality of alignment sections of the alignment curve is even number.

3. The multi-curve multi-section alignment structure according to claim 1, wherein the inner surface of the lens is aspheric.

4. A method of producing an orthokeratology lens with a multi-curve multi-section alignment structure, comprising:
(A): using a corneal topography to measure a cornea of an eyeball, to obtain a plurality of keratometry measurement of the cornea;
(B): using an electronic device to perform calculation of curvature for the cornea of the eyeball, dividing an alignment region, which matches with the alignment curve of the lens to be produced, of the cornea into a plurality of sections, and calculating keratometry measurement of the plurality of sections of the cornea to obtain curvatures of the plurality of sections by a preset algorithm;
(C): using a lens manufacturing machine to produce the orthokeratology lens based on the curvatures of the plurality of sections, wherein the alignment curve of the lens comprises a plurality alignment sections matching the curvatures of the plurality of sections.

5. The method according to claim 4, wherein the electronic device in the step (B) is a desktop computer, a notebook computer, or an industrial computer.

6. The method according to claim 4; wherein the amount of the plurality of alignment sections of the alignment curve in the step (B) is even number.

7. The method according to claim 4, wherein the curvature of nasal alignment curve of the orthokeratology lens is lower than the temporal curvature of the alignment curve of the orthokeratology lens.

8. The method according to claim 4, wherein the step (B) comprises:
using the electronic device to divide the alignment region of the cornea into eight sections; and
during the dividing process, first, dividing the alignment region of the cornea into four sections based on X axis and Y axis, and then dividing each of the four sections by 45 degrees, so as to divide the alignment region into the eight sections, and use the eight sections to make the alignment curve of the lens form the eight sections, thereby improving lens-corneal alignment.

9. The method according to claim 4, wherein in the step (B), the electronic device uses a central point of the cornea of the eyeball as an original point of a X and Y coordinate system, the preset algorithm is expressed as:
$$z = \frac{c {r}^{2}}{1 + \sqrt{1 - ( 1 + k ) {c}^{2} {r}^{2}}}$$
wherein z indicates a distance from the original point in the Y direction, c indicates a curvature of the central point of the cornea, r indicates a distance from the original point in the X direction, k indicates an asphericity, and k=−e², and e indicates eccentricity.

10. The method according to claim 4, wherein the lens production machine in the step (C) is an aspheric surface manufacturing machine used to produce the orthokeratology lens by an aspheric surface production manner.
